(19) United States
(12) Patent Application Publication
(10) Pub. No.: US 2019/0039184 A1
(43) Pub. Date: Feb. 7, 2019

(54) APPARATUS AND METHOD FOR AUTOMATIC COMPENSATION, AND SYNCHRONOUS CORRECTING AND STRENGTHENING WITH DUAL-LASER BEAMS

(71) Applicant: GUANGDONG UNIVERSITY OF TECHNOLOGY, GUANGZHOU (CN)

(72) Inventors: Yongkang ZHANG, GUANGZHOU (CN); Qiuyun YU, GUANGZHOU (CN); Zheng ZHANG, GUANGZHOU (CN); Qingtian YANG, GUANGZHOU (CN)

(73) Assignee: GUANGDONG UNIVERSITY OF TECHNOLOGY

(21) Appl. No.: 16/153,714

(22) Filed: Oct. 6, 2018

Related U.S. Application Data
(63) Continuation of application No. PCT/CN2017/094096, filed on Jul. 24, 2017.

(30) Foreign Application Priority Data
May 8, 2017 (CN) 201710316272.6

(51) Int. Cl. B23K 26/352; B23K 26/03; B23K 26/06; B23K 26/08

(52) U.S. Cl. CPC B23K 26/352; B23K 26/03; B23K 2101/001; B23K 26/0626; B23K 26/0823; B23K 26/0608

(57) ABSTRACT

A strengthening laser device of the present disclosure may freely move on both sides of a workpiece, so that a correcting laser device and the strengthening laser device are distributed on the same side or both sides of the workpiece. The correcting laser device performs a correcting procedure, and the strengthening laser device performs a strengthening procedure. An online monitoring system monitors the surface performance, a shape and a size of the workpiece. A real-time tracking feedback system feeds back the data monitored by the online monitoring system to a correcting laser device power adjustment apparatus and a strengthening laser device power adjustment apparatus for automatic compensation, so that a synergetic influence caused by synchronous correcting and strengthening for the workpiece is eliminated. The surface accuracy of the workpiece is improved, and the machining efficiency is increased to a large extent at the same time.

### CROSS-REFERENCE TO RELATED APPLICATIONS

This application is a continuation of International Patent Application No. PCT/CN2017/094096 with a filing date of Jul. 24, 2017, designating the United States, now pending, and further claims priority to Chinese Patent Application No. 201710316272.6 with a filing date of May 8, 2017. The content of the aforementioned applications, including any intervening amendments thereto, are incorporated herein by reference.

### TECHNICAL FIELD

The present disclosure relates to the technical field of additive manufacturing, and particularly relates to apparatus for automatic compensation and synchronous correcting and strengthening with dual-laser beams and a method thereof.

### BACKGROUND OF THE PRESENT INVENTION

At present, independent correction has some problems that: correction for a blisk and a blade of an aero-engine may damage structures of parts to a certain extent, change surface structures of metal materials, reduce the surface performance of a metal part, and lead to the fatigue performance and the surface accuracy of a structure can meet requirements hardly.

Independent strengthening has some problems that: only parts of regions are strengthened through the independent strengthening. The fatigue life of the blade is substantially prolonged after laser shock strengthening is performed. However, a problem of a large stress change range may occur. In order to avoid the above-mentioned phenomenon, the whole blade surface may be subjected to laser shock treatment, but this measure would greatly reduce the machining efficiency. Furthermore, the whole surface treatment may lead to a relatively large deformation of the blade due to release of a residual compressive stress, and then the usability of the blade is affected.

In the prior art, tracking detection in a part machining process, quality evaluation for the surface of a part, analysis of an overall structure of the part, and a control system, a feedback system and an adjustment device in the machining process basically work in a “One Step One Stop” manner. Namely, online tracking detection for the surface of the part is firstly performed, and then the feedback system transmits data information, and then the control system controls the adjustment device to machine the part. After the machining is completed, an online tracking detection system performs the quality evaluation on the surface of the part and analyzes the overall structure of the part.

Therefore, when workpieces such as the blisk and the blade of the aero-engine are corrected and strengthened step by step, separate effects of the workpieces may be interfered with one another and affect one other synergistically, thereby reducing the machining quality of the part. Meanwhile, an auxiliary system in the part machining process adopts the “One Step One Stop” working mode, which may lead to advancing and lagging phenomena, resulting in reduction of the working efficiency. Errors among all the steps and errors along all the links cause that the machining quality of the part fail to meet the requirement. Meanwhile, the fatigue life of the blade is substantially prolonged after the laser shock strengthening is performed, but the problem of the large stress change range may occur. However, the laser shock treatment for the whole blade surface may greatly reduce the machining efficiency and release the residual compressive stress, causing the relatively large deformation of the blade and affecting the usability of the blade.

### SUMMARY OF PRESENT INVENTION

Aiming at the shortcomings in the prior art, the present disclosure provides an apparatus for automatic compensation and synchronous correcting and strengthening with dual-laser beams which is high in machining efficiency, high in quality and long in service life and guarantees to meet production requirements.

In order to achieve the above-mentioned objective, a technical solution provided by the present disclosure is as follows: the apparatus includes a correcting laser device; a strengthening laser device; a correcting laser device control system and a strengthening laser device control system which respectively control the correcting laser device and the strengthening laser device; a correcting laser device power adjustment apparatus and a strengthening laser device power adjustment apparatus which respectively adjust power of the correcting laser device and power of the strengthening laser device; an online monitoring system for monitoring the surface performance, a shape and a size of a workpiece; a real-time tracking feedback system for feeding back data monitored by the online monitoring system to the correcting laser device power adjustment apparatus and the strengthening laser device power adjustment apparatus; a workpiece rotating apparatus for controlling rotation of the workpiece; and a computer.

The workpiece is fixed to the workpiece rotating apparatus. The correcting laser device and the strengthening laser device are located on a side of the workpiece. The correcting laser device control system is connected with the correcting laser device power adjustment apparatus and the correcting laser device respectively. The strengthening laser device control system is connected with the strengthening laser device power adjustment apparatus and the strengthening laser device respectively. The online monitoring system is connected with the correcting laser device power adjustment apparatus and the strengthening laser device power adjustment apparatus respectively through the real-time tracking feedback system. The workpiece rotating apparatus, the correcting laser device power adjustment apparatus, the strengthening laser device power adjustment apparatus and the real-time tracking feedback system are all connected with the computer, and are controlled by the computer.

The correcting laser device and the strengthening laser device may select different parameter specifications according to different requirements in correcting and strengthening processes.

The strengthening laser device may freely move around both sides of the workpiece, so that the correcting laser device and the strengthening laser device may be distributed on the same side of a blade to work synchronously. The online monitoring system is located between the correcting laser device and the strengthening laser device, and a spacing distance is obtained through blending analysis of corresponding temperature fields generated by correcting and strengthening, thereby realizing synchronization of the online monitoring system, the correcting laser device and the strengthening laser device. The correcting laser device and the strengthening laser device may be also distributed at corresponding positions on both sides of the blade to work synchronously. The correcting laser device and the strengthening laser device are symmetrically distributed about a central line, and the online monitoring system and the correcting laser device are located on the same side, spaced at a certain distance, thereby realizing synchronization of the online monitoring system, the correcting laser device and the strengthening laser device. An optimal working solution is selected through error analysis to facilitate improvement of the machining efficiency.

The online monitoring system is used to perform synchronous detection on the surfaces of workpieces. Surface information of the workpieces and parameter adjustment are transmitted to the correcting laser device power adjustment apparatus and the strengthening laser device power adjustment apparatus through the real-time tracking feedback system to respectively adjust parameters of the two laser devices. Correcting and strengthening are repeated for multiple times after automatic compensation is performed.

After the surface of one workpiece is machined, the workpiece rotating apparatus may rotate the workpiece to any angle and cooperate with the rotations of the two laser device at the same time to realize correcting and strengthening for the surface of the workpiece at any angle.

In order to achieve the above-mentioned objective, the present disclosure further provides a method for apparatus for automatic compensation and synchronous correcting and strengthening with dual-laser beams. The method includes the following steps:

(1) Acquiring original data:

The online monitoring system monitors size and shape parameters of a workpiece before the workpiece is subjected to synchronous correcting and strengthening. The computer stores data as original data X0. Meanwhile, the real-time tracking feedback system transmits information to the correcting laser device power adjustment apparatus and the strengthening laser device power adjustment apparatus. The computer records parameters of the correcting laser device and the strengthening laser device at this moment as original data M0 for parameter adjustment of the two laser devices.

(2) Analyzing an error:

The computer performs original data analysis and calculation when a blisk and a blade of an aero-engine accord with ideal conditions so as to obtain parameters X such as the size and the shape of the workpiece and parameters M of the laser devices, takes the parameters as synchronous correction and laser device parameter adjustment control standards, analyzes an error between the original data X0 and the ideal parameters X, and records the error as S0 which is used as original data for minimizing error in a synchronous correcting and strengthening process.

(3) Performing, by the correcting laser device and the strengthening laser device which are located on the same side, automatic compensation, synchronous correcting and strengthening:

The correcting laser device and the strengthening laser device are located on the same side of the workpiece. During correction by the correcting laser device, the online monitoring system performs real-time tracking, and feeds back the size parameter of the corrected workpiece to the strengthening laser device and the correcting laser device in sequence. The correcting laser device power adjustment apparatus and the strengthening laser device power adjustment apparatus respectively adjust the parameters of the correcting laser device and the strengthening laser device. The strengthening laser device is controlled to work synchronously, thereby realizing synchronization of correction-detection and feedback-strengthening.

(4) Performing data acquisition and error analysis after the synchronization of correction-detection and feedback-strengthening is realized on the same side:

The online monitoring system collects parameters X1 such as the surface performance, the shape and the size of the workpiece and parameters M1 of the two laser devices. The computer records and stores data, then feeds back the data to the correcting laser device power adjustment apparatus and the strengthening laser device power adjustment apparatus, performs error analysis, and records and stores data S1.

(5) Ending the machining if the parameters such as the surface performance, the shape and the size of the workpiece meet relevant requirements after the synchronization of correction-detection and feedback-strengthening is realized on the same side and the error is in an allowable error range at the same time, otherwise, entering Step (6).

(6) Performing, by the correcting laser device and the strengthening laser device which are located on two sides, automatic compensation, synchronous correcting and strengthening:

The correcting laser device and the strengthening laser device are respectively located on both sides of the workpiece to work. During correction by the correcting laser device, the online monitoring system performs real-time tracking, and feeds back the size parameter of the corrected workpiece to the strengthening laser device and the correcting laser device in sequence. The correcting laser device power adjustment apparatus and the strengthening laser device power adjustment apparatus respectively adjust the parameters of the correcting laser device and the strengthening laser device. The strengthening laser device control system controls the strengthening laser device to work synchronously, thereby realizing synchronization of correction-detection and feedback-strengthening.

(7) Performing data acquisition and error analysis after the synchronization of correction-detection and feedback-strengthening is realized on both sides:

The online monitoring system collects parameters X2 such as the surface performance and structural size of the workpiece and parameters M2 of the two laser devices. The computer records and stores data, then feeds back the data to the correcting laser device power adjustment apparatus and the strengthening laser device power adjustment apparatus, performs error analysis, and records and stores data S2.

(8) Ending the machining if the parameters such as the surface performance, the shape and the size of the workpiece meet relevant requirements after the synchronization of correction-detection and feedback-strengthening is realized on both sides and an error is in the allowable error range at the same time, otherwise, entering Step (9).

(9) Comparing and analyzing the data obtained by automatic compensation, synchronous correcting and strengthening performed by the correcting laser device and the strengthening laser device which are located on the same side with the data obtained by automatic compensation, synchronous correcting and strengthening performed by the correcting laser device and the strengthening laser device which are located on both sides, so as to select a working solution with an optimal effect.

(10) Continuously and repeatedly performing machining according to the optimal working solution until parameters Xn such as the surface performance, the shape and the size of the workpiece meet the relevant requirements and an error Sn is in the allowable error range.

Compared with the prior art, the principle and corresponding beneficial effects of the present technical solution are as follows:

In this solution, the strengthening laser device may freely move on both sides of the workpiece, so that the correcting laser device and the strengthening laser device are distributed on the same side or both sides of the workpiece. The correcting laser device performs a correcting procedure, and the strengthening laser device performs a strengthening procedure simultaneously, synchronously and synergistically. The online monitoring system monitors the surface performance, the shape and the size of the workpiece. The real-time tracking feedback system feeds back the data monitored by the online monitoring system to the correcting laser device power adjustment apparatus and the strengthening laser device power adjustment apparatus for automatic compensation. The correcting laser device, the strengthening laser device, the online monitoring system and the real-time tracking feedback system are configured to work synchronously and synergistically so that a synergetic influence caused by synchronous correcting and strengthening for the workpiece is eliminated. The surface accuracy of the workpiece is improved, and the machining efficiency is increased to a large extent at the same time. In addition, through cooperation between the computer and all modules, the error is analyzed through the acquired data, so as to select the optimal working solution to enable the workpiece to be continuously optimized to meet workpiece machining requirements.

### DESCRIPTION OF THE DRAWINGS

FIG. 1 is a structural schematic diagram when a correcting laser device and a strengthening laser device are located on the same side of a workpiece according to an embodiment of the present disclosure;

FIG. 2 is a structural schematic diagram when a correcting laser device and a strengthening laser device are located on both sides of a workpiece according to an embodiment of the present disclosure; and

FIG. 3 is a working principle diagram according to an embodiment of the present disclosure.

### DETAILED DESCRIPTION OF PREFERRED EMBODIMENTS

The present disclosure is further described below in combination with specific embodiments.

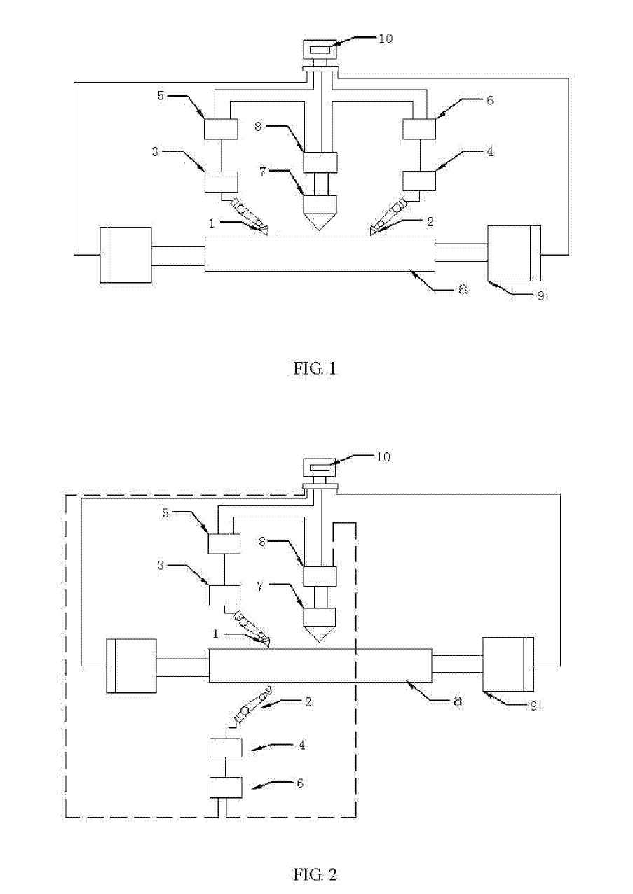

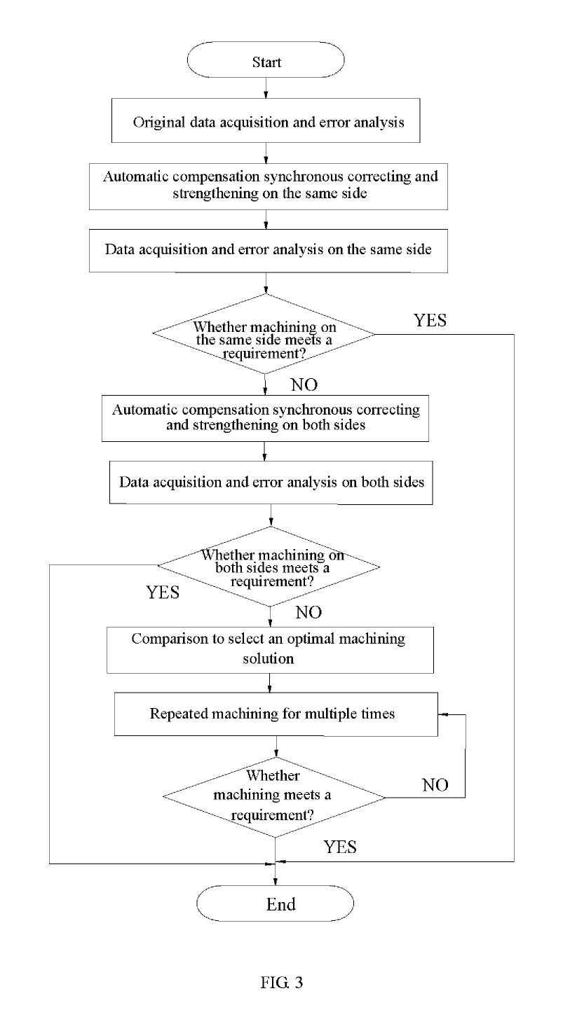

Referring to FIGS. 1 to 2, the present embodiment provides apparatus for automatic compensation and synchronous correcting and strengthening with dual-laser beams, including a correcting laser device 1; a strengthening laser device 2; a correcting laser device control system 3 and a strengthening laser device control system 4 which respectively control the correcting laser device 1 and the strengthening laser device 2; a correcting laser device power adjustment apparatus 5 and a strengthening laser device power adjustment apparatus 6 which respectively adjust power of the correcting laser device 1 and power of the strengthening laser device 2; an online monitoring system 7 for monitoring the surface performance, a shape and a size of a workpiece a; a real-time tracking feedback system 8 for feeding back data monitored by the online monitoring system 7 to the correcting laser device power adjustment apparatus 5 and the strengthening laser device power adjustment apparatus 6; a workpiece rotating apparatus 9 for controlling the workpiece a to rotate; and a computer 10.

The workpiece a is fixed to the workpiece rotating apparatus 9. The correcting laser device 1 and the strengthening laser device 2 are located on a side of the workpiece a. The correcting laser device control system 3 is connected with the correcting laser device power adjustment apparatus 5 and the correcting laser device 1 respectively. The strengthening laser device control system 4 is connected with the strengthening laser device power adjustment apparatus 6 and the strengthening laser device 2 respectively. The online monitoring system 7 is connected with the correcting laser device power adjustment apparatus 5 and the strengthening laser device power adjustment apparatus 6 respectively through the real-time tracking feedback system 8. The workpiece rotating apparatus 9, the correcting laser device power adjustment apparatus 5, the strengthening laser device power adjustment apparatus 6 and the real-time tracking feedback system 8 are all connected with the computer 10, and are controlled by the computer 10.

The correcting laser device 1 and the strengthening laser device 2 may select different parameter specifications according to different requirements in correcting and strengthening processes.

The strengthening laser device 2 may freely move on both sides of the workpiece a, so that the correcting laser device 1 and the strengthening laser device 2 may be distributed on the same side of the workpiece a to work synchronously, and may be also distributed at corresponding positions on both sides of the workpiece a to work synchronously. An optimal working solution is selected through error analysis to facilitate improvement of the machining efficiency.

The online monitoring system 7 is used to perform synchronous detection on the surfaces of workpieces a. Surface information of the workpieces a and parameter adjustment are transmitted to the correcting laser device power adjustment apparatus 5 and the strengthening laser device power adjustment apparatus 6 through the real-time tracking feedback system 8 to respectively adjust parameters of the two laser devices. Correcting and strengthening are repeated for multiple times after automatic compensation is performed.

After the surface of one workpiece a is machined, the workpiece rotating apparatus 9 may rotate the workpiece a to any angle and cooperate with the rotations of the two laser device at the same time to realize correcting and strengthening for the surface of the workpiece a at any angle.

As shown in FIG. 3, specific working steps are as follows:

(1) Acquiring original data:

The online monitoring system 7 monitors size and shape parameters of the workpiece a before the workpiece a is subjected to synchronous correcting and strengthening. The computer 10 stores data as original data X0. Meanwhile, the real-time tracking feedback system 8 transmits information to the correcting laser device power adjustment apparatus 5 and the strengthening laser device power adjustment apparatus 6. The computer 10 records parameters of the correcting laser device 1 and the strengthening laser device 2 at this moment as original data M0 for parameter adjustment of the two laser devices.

(2) Analyzing an error:

The computer 10 performs original data analysis and calculation when a blisk and a blade of an aero-engine accord with ideal conditions so as to obtain parameters X such as the size and the shape of the workpiece a and parameters M of the laser devices, takes the parameters as synchronous correction and laser device parameter adjustment control standards, analyzes an error between the original data X0 and the ideal parameters X, and records the error as S0 which is used as original data for minimizing error in a synchronous correcting and strengthening process.

(3) Performing, by the correcting laser device 1 and the strengthening laser device 2 which are located on the same side, automatic compensation, synchronous correcting and strengthening:

The correcting laser device 1 and the strengthening laser device 2 are located on the same side of the workpiece a to work. During correction by the correcting laser device 1, the online monitoring system 7 performs real-time tracking, and feeds back the size parameter of the corrected workpiece a to the strengthening laser device 2 and the correcting laser device 1 in sequence. The correcting laser device power adjustment apparatus 5 and the strengthening laser device power adjustment apparatus 6 respectively adjust the parameters of the correcting laser device 1 and the strengthening laser device 2. The strengthening laser device control system 4 controls the strengthening laser device 2 to work synchronously, thereby realizing synchronization of correction-detection and feedback-strengthening.

(4) Performing data acquisition and error analysis after the synchronization of correction-detection and feedback-strengthening is realized on the same side:

The online monitoring system 7 collects parameters X1 such as the surface performance, the shape and the size of the workpiece a and parameters M1 of the two laser devices. The computer 10 records and stores data, then feeds back the data to the correcting laser device power adjustment apparatus 5 and the strengthening laser device power adjustment apparatus 6, performs error analysis, and records and stores data S1.

(5) Ending the machining if the parameters such as the surface performance, the shape and the size of the workpiece meet relevant requirements after the synchronization of correction-detection and feedback-strengthening is realized on the same side and an error is in an allowable error range at the same time, otherwise, entering Step (6).

(6) Performing, by the correcting laser device 1 and the strengthening laser device 2 which are located on two sides, automatic compensation, synchronous correcting and strengthening:

The correcting laser device and the strengthening laser device are respectively located on both sides of the workpiece. During correction by the correcting laser device, the online monitoring system performs real-time tracking, and feeds back the size parameter of the corrected workpiece to the strengthening laser device and the correcting laser device in sequence. The correcting laser device power adjustment apparatus and the strengthening laser device power adjustment apparatus respectively adjust the parameters of the correcting laser device and the strengthening laser device. The strengthening laser device control system controls the strengthening laser device to work synchronously, thereby realizing synchronization of correction-detection and feedback-strengthening.

(7) Performing data acquisition and error analysis after the synchronization of correction-detection and feedback-strengthening is realized on both sides:

The online monitoring system 7 collects parameters X2 such as the surface performance and a structural size of the workpiece a and parameters M2 of the two laser devices. The computer 10 records and stores data, then feeds back the data to the correcting laser device power adjustment apparatus 5 and the strengthening laser device power adjustment apparatus 6, performs error analysis, and records and stores data S2.

(8) Ending the machining if the parameters such as the surface performance, the shape and the size of the workpiece meet relevant requirements after the synchronization of correction-detection and feedback-strengthening is realized on both sides and an error is in the allowable error range at the same time, otherwise, entering Step (9);

(9) Comparing and analyzing the data obtained by automatic compensation, synchronous correcting and strengthening performed by the correcting laser device 1 and the strengthening laser device 2 which are located on the same side with the data obtained by automatic compensation, synchronous correcting and strengthening performed by the correcting laser device 1 and the strengthening laser device 2 which are located on both sides, so as to select a working solution with an optimal effect.

(10) Continuously and repeatedly performing machining according to the optimal working solution until parameters Xn such as the surface performance, the shape and the size of the workpiece a meet the relevant requirements and an error Sn is in the allowable error range.

In the present embodiment, the strengthening laser device 2 may freely move on both sides of the workpiece a, so that the correcting laser device 1 and the strengthening laser device 2 are distributed on the same side or both sides of the workpiece a. The correcting laser device 1 performs a correcting procedure, and the strengthening laser device 2 performs a strengthening procedure simultaneously, synchronously and synergistically. The online monitoring system 7 monitors the surface performance, the shape and the size of the workpiece a. The real-time tracking feedback system 8 feeds back the data monitored by the online monitoring system 7 to the correcting laser device power adjustment apparatus 5 and the strengthening laser device power adjustment apparatus 6 for automatic compensation. The correcting laser device, the strengthening laser device, the online monitoring system and the real-time tracking feedback system are configured to work synchronously and synergistically so that the synergetic influence caused by synchronous correcting and strengthening for the workpiece a is eliminated. The surface accuracy of the workpiece a is improved, and the machining efficiency is increased to a large extent at the same time. In addition, through cooperation between the computer 10 and all modules, the error is analyzed through the acquired data, so as to select the optimal working solution to enable the workpiece a to be continuously optimized to meet workpiece machining requirements.

The above-mentioned embodiments are only preferred embodiments of the present disclosure, but not intended to limit the implementation scope of the present disclosure. Therefore, any variation made on the basis of the shape and the principle of the present disclosure shall fall within the protection scope of the present disclosure.

We claim:

1. An apparatus for automatic compensation and synchronous correcting and strengthening with dual-laser beams, comprising:
a correcting laser device (1);
a strengthening laser device (2);
a correcting laser device control system (3) for controlling the correcting laser device (1);
a strengthening laser device control system (4) for controlling the strengthening laser device (2);
a correcting laser device power adjustment apparatus (5) for adjusting power of the correcting laser device (1);
a strengthening laser device power adjustment apparatus (6) for adjusting power of the strengthening laser device (2);
an online monitoring system (7) for monitoring surface performance, a shape and a size of a workpiece;
a real-time tracking feedback system (8) for feeding back data monitored by the online monitoring system (7) to the correcting laser device power adjustment apparatus (5) and the strengthening laser device power adjustment apparatus (6);
a workpiece rotating apparatus (9) for controlling rotation of the workpiece; and
a computer (10); wherein the workpiece is fixed to the workpiece rotating apparatus (9); the correcting laser device (1) and the strengthening laser device (2) are located on a side of the workpiece; the correcting laser device control system (3) is connected with the correcting laser device power adjustment apparatus (5) and the correcting laser device (1) respectively; the strengthening laser device control system (4) is connected with the strengthening laser device power adjustment apparatus (6) and the strengthening laser device (2) respectively; the online monitoring system (7) is connected with the correcting laser device power adjustment apparatus (5) and the strengthening laser device power adjustment apparatus (6) respectively through the real-time tracking feedback system (8); and the workpiece rotating apparatus (9), the correcting laser device power adjustment apparatus (5), the strengthening laser device power adjustment apparatus (6) and the real-time tracking feedback system (8) are all connected with the computer (10), and are controlled by the computer (10).

2. The apparatus for automatic compensation and synchronous correcting and strengthening with dual-laser beams according to claim 1, wherein the strengthening laser device (2) is capable of freely moving around both sides of the workpiece.

3. A method for automatic compensation and synchronous correcting and strengthening with dual-laser beams for the apparatus according to claim 1, comprising the following steps:
(1) acquiring original data wherein an online monitoring system monitors size and shape parameters of a workpiece before the workpiece is subjected to synchronous correcting and strengthening; a computer stores data as original data X0; a real-time tracking feedback system transmits information to a correcting laser device power adjustment apparatus and a strengthening laser device power adjustment apparatus; the computer records parameters of a correcting laser device and a strengthening laser device at this moment as original data M0 for parameter adjustment of the two laser devices;
(2) analyzing an error wherein the computer performs original data analysis and calculation when a blisk and a blade of an aero-engine accord with ideal conditions so as to obtain parameters X such as the size and the shape of the workpiece and parameters M of the laser devices, takes the parameters as synchronous correction and laser device parameter adjustment control standards, analyzes an error between the original data X0 and the ideal parameters X, and records the error as S0 which is used as original data for minimizing error in a synchronous correcting and strengthening process;
(3) performing, by the correcting laser device and the strengthening laser device which are located on the same side, automatic compensation, synchronous correcting and strengthening wherein the correcting laser device and the strengthening laser device are located on the same side of the workpiece to work; during correction by the correcting laser device, the online monitoring system performs real-time tracking, and feeds back the size parameter of the corrected workpiece to the strengthening laser device and the correcting laser device in sequence; the correcting laser device power adjustment apparatus and the strengthening laser device power adjustment apparatus respectively adjust the parameters of the correcting laser device and the strengthening laser device; the strengthening laser device control system controls the strengthening laser device to work synchronously, thereby realizing synchronization of correction-detection and feedback-strengthening;
(4) performing data acquisition and error analysis after the synchronization of correction-detection and feedback-strengthening is realized on the same side wherein the online monitoring system collects parameters X1 such as the surface performance, the shape and the size of the workpiece and parameters M1 of the two laser devices; the computer records and stores data, then feeds back the data to the correcting laser device power adjustment apparatus and the strengthening laser device power adjustment apparatus, performs error analysis, and records and stores data S1;
(5) ending the machining if the parameters such as the surface performance, the shape and the size of the workpiece meet relevant requirements after the synchronization of correction-detection and feedback-strengthening is realized on the same side and an error is in an allowable error range at the same time, otherwise, entering Step (6);
(6) performing, by the correcting laser device and the strengthening laser device which are located on both sides, automatic compensation, synchronous correcting and strengthening;
(7) performing data acquisition and error analysis after the synchronization of correction-detection and feedback-strengthening is realized on both sides wherein the online monitoring system collects parameters X2 such as the surface performance and the structural size of the workpiece and parameters M2 of the two laser devices; the computer records and stores data, then feeds back the data to the correcting laser device power adjustment apparatus and the strengthening laser device power adjustment apparatus, performs error analysis, and records and stores data S2.
(8) ending the machining if the parameters such as the surface performance, the shape and the size of the workpiece meet relevant requirements after the synchronization of correction-detection and feedback-strengthening is realized on both sides and an error is in the allowable error range at the same time, otherwise, entering Step (9);
(9) comparing and analyzing the data obtained by automatic compensation, synchronous correcting and strengthening performed by the correcting laser device and the strengthening laser device which are located on the same side with the data obtained by automatic compensation, synchronous correcting and strengthening performed by the correcting laser device and the strengthening laser device which are located on both sides, so as to select a working solution with an optimal effect; and
(10) continuously and repeatedly machining according to the optimal working solution until parameters Xn such as the surface performance, the shape and the size of the workpiece meet the relevant requirements and an error Sn is in the allowable error range.
